(19) United States
(12) Patent Application Publication
(10) Pub. No.: US 2014/0192716 A1
(43) Pub. Date: Jul. 10, 2014

(54) Methods and Apparatuses for Managing Acknowledgements

(71) Applicant: Broadcom Corporation, Irvine, CA (US)

(72) Inventors: Anna PANTELIDOU, Oulu (FI); Timo Kalevi KOSKELA, Oulu (FI); Sami-Jukka HAKOLA, Kempele (FI); Samuli TURTINEN, Ii (FI)

(73) Assignee: Broadcom Corporation, Irvine, CA (US)

(21) Appl. No.: 14/146,897

(22) Filed: Jan. 3, 2014

(30) Foreign Application Priority Data
Jan. 4, 2013 (GB) 1300143.3

(51) Int. Cl. H04W 28/02

(52) U.S. Cl. CPC H04W 28/02
USPC 370/328

(57) ABSTRACT

A method, apparatus and computer program product are provided for designating an acknowledgment of data. A method and apparatus may designate a mode of operation, in a signal, for acknowledging receipt of data. The method and apparatus may assign an aggregation period, to the signal, including a time period in which one or more stations are designated to communicate one or more items of data to an intermediate node. The method and apparatus may also transmit the signal to enable the stations to detect the designated mode of operation and the time period of the assigned aggregation period in which to communicate the items of data to the intermediate node.

### TECHNICAL FIELD

Embodiments of the present invention relate generally to wireless communications technology and, more particularly, to a method and apparatus for facilitating aggregation of data during an aggregation period and acknowledging receipt of the aggregated data.

### BACKGROUND

Currently, access points (APs) are capable of supporting a large number of associated stations (STAs) which may operate on a very strict energy budget. As such, in Institute of Electrical and Electronics Engineers (IEEE) 802.11 networks it is possible that the APs and the STAs transmit at very asymmetric rates. This rate asymmetry may result in three different scenarios. First, an AP may hear all the STAs in a network and the STAs may hear the AP. Even in instances in which the AP and STAs may hear each other, the STAs may communicate with an AP via one or more intermediate nodes, such as relays. The relay(s) may receive and forward transmissions of STAs to the AP and may further receive and forward the transmissions of the AP to the STAs. In this regard, STAs may use lower transmission power to reach the intermediate nodes which may then forward the transmissions to a destination node such as, for example, an AP.

Second, even though an AP may transmit and reach all the STAs in a network, the STAs may be unable to directly reach the AP. However, the STAs may reach the AP by communicating via a relay. Another case that falls in this second scenario is the case when even though a STA may reach an AP the AP may be unable to reach the STA, at least with a satisfying performance, for example, due to the STA's location in the network. In those two cases, using relays can increase the communication rates, reduce the energy consumption and further improve the network range.

Third, the rate asymmetry addresses the case where, neither the AP(s) or the STAs are in coverage of each other and as such the use of one or more relays may be needed to extend coverage in both directions, namely the only way that an AP may communicate with the STAs is through a relay(s) and the STAs may communicate with an AP through the relay(s).

In addition, networks using sensor and meter to pole applications (e.g., IEEE 802.11ah) may utilize relays. In the sensor and meter to pole applications, an AP may serve a large number of sensors over a range that may potentially be equal to 1 kilometer (km). When the STAs are equipped with a power amplifier, reasonable rates may be achieved at this range. However, to further reduce the energy consumption of the network, the power amplifiers may need to be removed from the sensors (at least in some instances). If this happens, the achievable rates of the STAs may become very low compared to the transmission rate of the AP leading to a link-rate asymmetry situation. For example, it is possible that even if the STAs may hear the AP, the AP may be unable to hear the STAs. Furthermore, this range of 1 km may not be feasible when the power amplifier is removed from the STAs. In these instances, range extension via one or more relays may be needed. For example, one way to increase the range is to deploy relays and support multi-hopping from the STAs to the AP.

At present, one problem of using relays may involve an undesirable delay in a channel being free for communications. For instance, the relays and STAs may utilize distributed coordination function (DCF) which may require a STA and/or relay desiring to transmit to listen for the channel status for a DCF Interframe Space (DIFS) interval. If the channel is found busy during the DIFS interval, the STA and/or relay may defer transmission(s). In a network a number of STAs and/or relays may contend for a channel. As such, in an instance in which multiple STAs and/or relays sense the channel is busy and defer their access, they may also simultaneously detect when the channel is released and may then attempt to access the channel. In order to avoid such collisions, DCF specifies a random backoff (also referred to herein as random access), which may force STAs and/or relays to defer their access to a channel for a time period.

Additionally, DCF includes a positive acknowledgement scheme, which means that if a frame is successfully received by a destination node, the destination node needs to send an acknowledgement (ACK) frame to notify the source or sender of the frame of the successful reception. At present, the destination node waits a Short Interframe Space (SIFS) time interval after receiving the data frame to send the ACK.

By using relays, the performance of a network may not be optimal and may be inefficient if a STA first performs random access to contend for the channel to transmit traffic to a relay and then the relay sends an ACK to the STA indicating that the traffic was successfully received. Additionally, the relay may have to wait a SIFS time interval after receipt of the traffic to send the ACK. Thereafter, the relay may need to contend for the channel to send the traffic received from the STA to an AP and the AP may need to send the relay an ACK indicating that the AP successfully received the traffic. The relay may need to wait a time interval associated with the SIFS to send the ACK to the AP. The time delay associated with the contentions for the channel and sending of the acknowledgements after SIFS are undesirable and may keep the channel busy for a considerable amount of time.

### SUMMARY

A method, apparatus and computer program product are therefore provided according to an example embodiment in order to provide an efficient and reliable manner for aggregating data in an aggregation period and acknowledging receipt of the aggregated data.

In an example embodiment, a mode of operation may be determined based in part on analyzing data (e.g., a bit, an information element) in a signal (e.g., a beacon). An example embodiment may enable an intermediate node to aggregate items of data (e.g., data packets, traffic data) during the aggregation period. The items of data may be received from one or more stations during the aggregation period.

The items of data may be acknowledged by a destination node in an instance in which the items of data are received by the destination node (e.g., an access point) and as such an intermediate node (e.g., a relay) may not need to acknowledge received items of data.

In one example embodiment, a method is provided that includes designating a mode of operation, in a signal, for acknowledging receipt of data. The method of this embodiment also includes assigning an aggregation period, to the signal. The aggregation period includes a time period in which one or more stations are designated to communicate one or more items of data to an intermediate node. The method also includes causing transmission of the signal to enable the one or more stations to detect the designated mode of operation and the time period of the assigned aggregation period in which to communicate the items of data to the intermediate node.

In another example embodiment, an apparatus is provided that comprises a processing system, which may be embodied by at least one processor and at least one memory including computer program code. The processing system is arranged to cause the apparatus to at least designate a mode of operation, in a signal, for acknowledging receipt of data. The processing system is also arranged to cause the apparatus to cause transmission of the signal to enable the one or more stations to detect the designated mode of operation and the time period of the assigned aggregation period in which to communicate the items of data to the intermediate node.

In yet another example embodiment, a computer program product is provided that includes at least one non-transitory computer-readable storage medium having computer-readable program instructions configured to designate a mode of operation, in a signal, for acknowledging receipt of data. The computer-readable program instructions, when executed by an apparatus, cause the apparatus to assign an aggregation period, to the signal, including a time period in which one or more stations are designated to communicate one or more items of data to an intermediate node. The computer-readable program instructions, when executed by the apparatus, cause transmission of the signal to enable the one or more stations to detect the designated mode of operation and the time period of the assigned aggregation period in which to communicate the items of data to the intermediate node.

In a further example embodiment, an apparatus is provided that includes means for designating a mode of operation, in a signal, for acknowledging receipt of data. The apparatus of this embodiment also includes means for assigning an aggregation period, to the signal, including a time period in which one or more stations are designated to communicate one or more items of data to an intermediate node. The apparatus of this embodiment also includes means for causing transmission of the signal to enable the one or more stations to detect the designated mode of operation and the time period of the assigned aggregation period in which to communicate the items of data to the intermediate node.

The aforementioned embodiments may be conducted by an access point or a base station when designating an acknowledgement of content.

In yet another example embodiment, a method is provided that includes detecting, via a signal, a designated mode of operation for acknowledging receipt of data and an assigned aggregation period including a time period in which to communicate with one or more stations. The method of this embodiment also includes receiving one or more items of data from the one or more stations during the time period of the aggregation period.

In another example embodiment, an apparatus is provided that includes a processing system, which may be embodied by at least one processor and at least one memory including computer program code. The processing system is arranged to cause the apparatus to at least detect, via a signal, a designated mode of operation for acknowledging receipt of data and an assigned aggregation period comprising a time period in which to communicate with one or more stations. The processing system is also configured to receive one or more items of data from the one or more stations during the time period of the aggregation period.

In a further example embodiment, a computer program product is provided that includes at least one non-transitory computer-readable storage medium having computer-readable program instructions stored therein with the computer-readable program instructions, when executed by an apparatus, causing the apparatus to detect, via a signal, a designated mode of operation for acknowledging receipt of data and an assigned aggregation period comprising a time period in which to communicate with one or more stations. The computer-readable program instructions, when executed by the apparatus, also cause the apparatus to receive one or more items of data from the one or more stations during the time period of the aggregation period.

In another example embodiment, an apparatus is provided that includes means for detecting, via a signal, a designated mode of operation for acknowledging receipt of data and an assigned aggregation period including a time period in which to communicate with one or more stations. The apparatus of this embodiment also includes means for receiving one or more items of data from the one or more stations during the time period of the aggregation period.

The aforementioned embodiments may be conducted by a relay or a user station when detecting a designated acknowledgement of data.

In yet another example embodiment, a method is provided that includes detecting, via a signal, a designated mode of operation for acknowledging receipt of data and an assigned aggregation period including a time period in which to communicate with an intermediate node. The method of this embodiment also includes facilitating communications of one or more items of data to the intermediate node during the time period of the aggregation period.

In another example embodiment, an apparatus is provided that includes a processing system, which may be embodied by at least one processor and at least one memory including computer program code. The processing system is arranged to cause the apparatus to detect, via a signal, a designated mode of operation for acknowledging receipt of data and an assigned aggregation period including a time period in which to communicate with an intermediate node. The processing system is also arranged to cause the apparatus to facilitating communications of one or more items of data to the intermediate node during the time period of the aggregation period.

In a further example embodiment, a computer program product is provided that includes at least one non-transitory computer-readable storage medium having computer-readable program instructions stored therein with the computer-readable program instructions including program instructions, when executed by an apparatus, causing the apparatus to detect, via a signal, a designated mode of operation for acknowledging receipt of data and an assigned aggregation period comprising a time period in which to communicate with an intermediate node. The computer-readable program instructions, when executed by an apparatus, cause the apparatus to facilitate communications of one or more items of data to the intermediate node during the time period of the aggregation period.

In another example embodiment, an apparatus is provided that includes means for detecting, via a signal, a designated mode of operation for acknowledging receipt of data and an assigned aggregation period including a time period in which to communicate with an intermediate node. The apparatus of this embodiment also includes means for facilitating communications of one or more items of data to the intermediate node during the time period of the aggregation period.

The aforementioned embodiments may be conducted by a user station when detecting a designated acknowledgement of data

### BRIEF DESCRIPTION OF THE DRAWINGS

Having thus described some embodiments of the invention in general terms, reference will now be made to the accompanying drawings, which are not necessarily drawn to scale, and wherein:

FIG. 1 is a schematic representation of a system that may benefit from an example embodiment;

FIG. 2 is a schematic block diagram of an apparatus from the perspective of an access point in accordance with an example embodiment;

FIG. 3 is a block diagram of an apparatus that may be embodied by a mobile terminal in accordance with an example embodiment;

FIG. 4 is a diagram of a system in accordance with one example embodiment;

FIG. 5 is a diagram of a signaling flow in accordance with an example embodiment;

FIG. 6 is a diagram of another signaling flow in accordance with another example embodiment;

FIG. 7 is a diagram of a block ACK with an aggregation period in accordance with an example embodiment;

FIG. 8 is a flowchart illustrating operations performed in accordance with one example embodiment;

FIG. 9 is a flowchart of operations performed in accordance with another example embodiment; and

FIG. 10 is a flowchart of operations performed in accordance with yet another example embodiment.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and

(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

At present, existing networks such as, for example, IEEE 802.11 and IEEE 802.11ah networks may utilize DCF which includes a positive acknowledge scheme. As such, in an instance in which a data frame is successfully received by an intermediary node (e.g., a relay), and/or a destination node, the destination node/intermediary node sends an ACK frame to notify the source/sender of the successful reception of the data frame.

In existing networks, in an instance in which a STA sends data to a relay, the STA may have to store the data sent to the relay, for example, in a queue/buffer until the relay sends an ACK indicating successful reception of the data. The STA may delete the data from a queue/buffer when the STA receives the ACK from the relay. Thereafter, the relay may contend for the channel and send the data, received from the STA, to an AP. The relay may store the data, for example, in a queue/buffer until the relay receives an ACK from the AP indicating that the AP successfully received the data. The relay may delete the stored data in the queue upon receiving an ACK from the AP indicating that the data was successfully received. This process utilized by existing networks may be inefficient since a wireless medium such as, for example, the channel is being consumed for signaling associated with contending for a channel and sending multiple ACKs and as such may kept busy for an undesirable amount of time instead of being utilized for communicating traffic data.

As such, it may be beneficial to provide a mechanism to more reliably and efficiently communicate and acknowledge receipt of data.

In this regard, an example embodiment may define an aggregation period. By utilizing the aggregation period, instead of sending a single packet and then having to acknowledge receipt of the single packet, a relay may aggregate multiple packets sent from a STA or multiple STAs (e.g., a group of STAs). At the end of this aggregation period, the relay may send all the packets to an access point and the access point may send an acknowledgment indicating that the packets were successfully received. In an instance in which the STA, or multiple STAs, may hear (e.g., within a proximity to detect communications from the access point) the access point, the STA, or multiple STAs may receive the ACK (e.g., a block ACK) directly from the access point. On the other hand, in an instance in which the STA, or multiple STAs, is unable to hear (e.g., too far away from the access point to detect communications), the relay may receive the ACK and may send the ACK to the STA, or the multiple STAs.

As such, an access point may send an ACK, indicating that packets were successfully received, per two hops instead of an ACK per hop. Sending an ACK per hop as with existing networks consumes resources and keeps the channel busy.

At present, existing networks may facilitate receipt of multiple packets from a STA but a relay may need to send a block ACK to the STA acknowledging receipt of the packets. However, the relay may need to forward the multiple packets to an AP and wait for another block ACK to be received from the AP indicating the packets were received. An example embodiment may not need to utilize two ACKs in an instance such as this and instead may utilize a single ACK to acknowledge receipt of multiple packets. Another drawback of existing approaches is that multiple packets are aggregated from the same STA. In this regard, the existing approaches may not aggregate packets from multiple different stations.

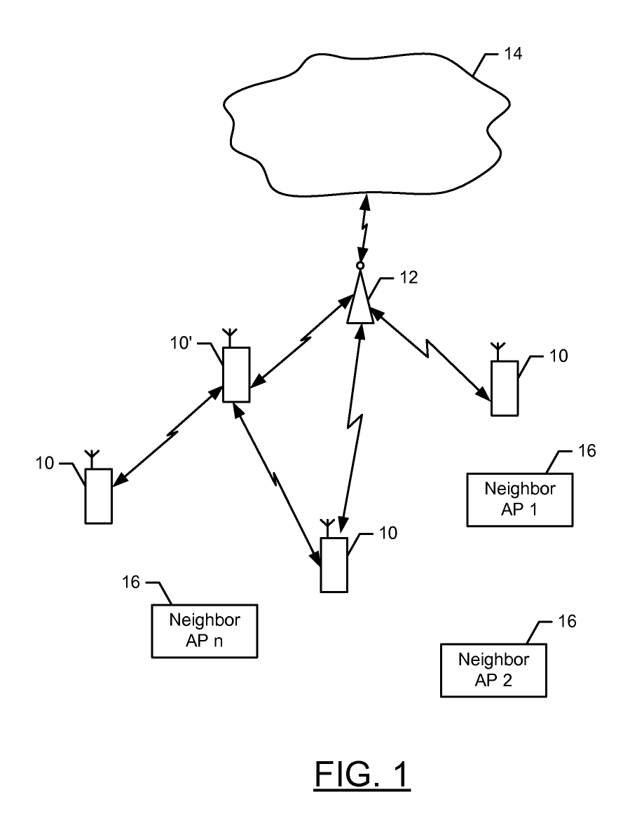

Referring now to FIG. 1, a system according to an example embodiment is provided. The system of FIG. 1 includes a first communication device (e.g., mobile terminal 10) that is capable of communication via a serving AP 12, such as a base station, a Node B, an evolved Node B (eNB), a radio network controller (RNC), an access point (AP), with a network 14 (e.g., a core network). While the network may be configured in accordance with Universal Mobile Telecommunications System (UMTS), Long Term Evolution (LTE™) or LTE-Advanced (LTE-A™), other networks may support the method, apparatus and computer program product of embodiments of the present invention including those configured in accordance with wideband code division multiple access (W-CDMA), CDMA2000, global system for mobile communications (GSM), general packet radio service (GPRS), a IEEE 802.11 system, a IEEE 802.11 ah system, and/or the like.

The network 14 may include a collection of various different nodes, devices or functions that may be in communication with each other via corresponding wired and/or wireless interfaces. For example, the network may include one or more cells or basic service sets (BSSs), including serving access point (AP) 12 and one or more neighbor access points 16 (designated neighbor AP 1, neighbor AP 2, . . . neighbor AP n in the embodiment of FIG. 1), each of which may serve a respective coverage area of a BSS. In one example embodiment, a source cell and neighboring cells could be, for example, part of one or more cellular or mobile networks or public land mobile networks (PLMNs). In turn, other devices such as processing devices (e.g., personal computers, server computers or the like) may be coupled to the mobile terminal 10 and/or other communication devices via the network.

For example, the mobile terminals 10 may communicate with one or more mobile terminals 10′ which may be an intermediate node(s) (e.g., a relay device (also referred to herein as relay)). In this regard, the mobile terminal(s) 10′ may facilitate communications between the serving AP 12 (also referred to herein as AP 12) and mobile terminals 10 (also referred to herein as stations). In other words, the mobile terminal 10′ may operate in a relay mode as an intermediate node that is configured to receive data from and transmit data to other communication devices (e.g., mobile terminals 10, APs 12, neighbor APs 16 (also referred to herein as neighbor APs 16). The mobile terminal 10 may operate as a station (e.g., a Wi-Fi station, a WLAN station) that is configured to transmit data to and receive data from a mobile terminal 10′ that operates in a relay mode and may also be configured to communicate directly with an AP (e.g., AP(s) 12, neighbor AP(s) 16).

A communication device, such as the mobile terminal 10 and mobile terminal 10′ (also referred to herein as User Equipment (UE) 10, UE 10′), may be in communication with other communication devices or other devices via a source cell or serving AP 12 and, in turn, the network 14. In some cases, the communication device may include an antenna for transmitting signals to and for receiving signals from a serving AP.

In some example embodiments, the mobile terminal 10 and/or mobile terminal 10′ may be a mobile communication device(s) such as, for example, a mobile telephone, portable digital assistant (PDA), pager, laptop computer, or any of numerous other hand held or portable communication devices, computation devices, content generation devices, content consumption devices, sensors (e.g., gas meters, temperature meters, electricity meters, etc.), or combinations thereof. As such, the mobile terminal 10 and mobile terminal 10′ may include one or more processors that may define processing circuitry either alone or in combination with one or more memories. The processing circuitry may utilize instructions stored in the memory to cause the mobile terminal 10 (e.g., a STA) and/or mobile terminal 10′ (e.g., a relay) to operate in a particular way or execute specific functionality when the instructions are executed by the one or more processors. The mobile terminal 10 and mobile terminal 10′ may also include communication circuitry and corresponding hardware/software to enable communication with other devices and/or the network 14.

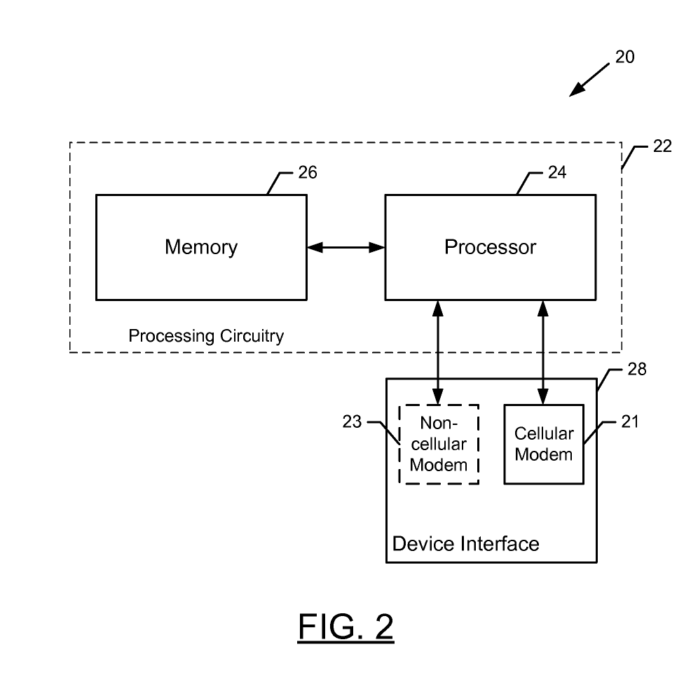

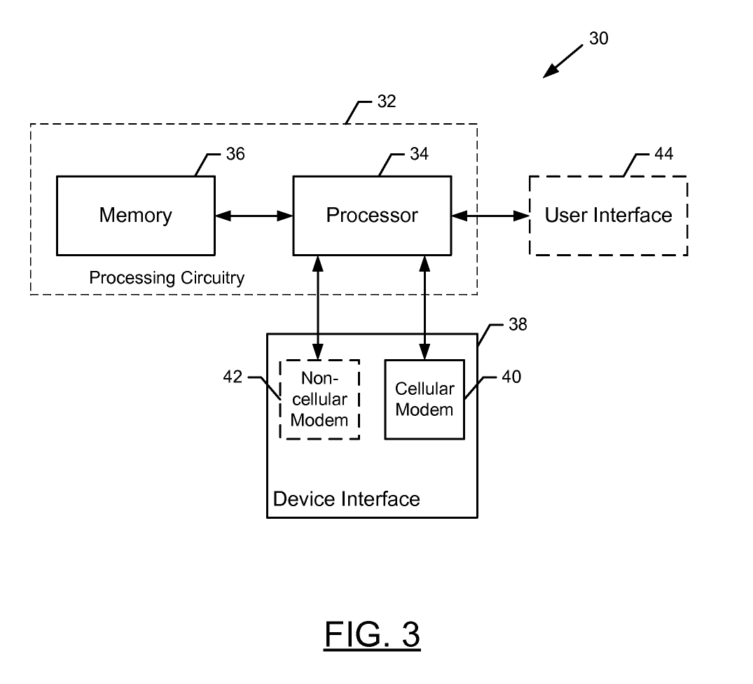

In one embodiment, for example, a neighbor AP 16 and/or the AP 12 may be embodied as or otherwise include an apparatus 20 as generically represented by the block diagram of FIG. 2. In an example embodiment, the AP 12 and/or the neighbor AP 16 may be, for example, a Wi-Fi AP, a WLAN AP or the like. Additionally, in one example embodiment, the mobile terminal 10 and mobile terminal 10′ may be embodied as or otherwise include an apparatus 30 as generically represented by the block diagram of FIG. 3. While the apparatus 20 may be employed, for example, by an AP 12, or a neighbor AP 16 and the apparatus 30 may be employed, for example, by a mobile terminal 10 or an mobile terminal 10′, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 20 may include or otherwise be in communication with a processing system including, for example, processing circuitry 22 that is configurable to perform actions in accordance with example embodiments described herein. The processing circuitry may be configured to perform data processing, application execution and/or other processing and management services according to an example embodiment of the invention. In some example embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 22 may include a processor 24 and memory 26 that may be in communication with or otherwise control a device interface 28. As such, the processing circuitry may be embodied as a circuit chip (e.g., an integrated circuit chip) configured (e.g., with hardware, software or a combination of hardware and software) to perform operations described herein in relation to the apparatus 20. In an alternative example embodiment, the processing circuitry 22 may be embodied in a modem (e.g., cellular modem 21 and/or non-cellular modem 23).

The device interface 28 may include one or more interface mechanisms for enabling communication with other devices, such as one or more mobile terminals 10 and/or mobile terminals 10′. In some cases, the device interface may be any means such as a device or circuitry embodied in either hardware, or a combination of hardware and software that is configured to receive and/or transmit data from/to a network and/or any other device or module in communication with the processing circuitry 22. In this regard, the device interface may include, for example, an antenna (or multiple antennas) and supporting hardware and/or software for enabling communications with a wireless communication network and/or a communication modem, such as a cellular modem 21 (e.g., a UMTS modem, a LTE modem, etc.), and/or an optional non-cellular modem 23 (e.g., a Wi-Fi modem, WLAN modem, etc.) for enabling communications with other terminals (e.g., Wi-Fi terminals, WLAN terminals, other APs, etc).

In an example embodiment, the memory 26 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 26 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

In one embodiment, the mobile terminals 10 and/or mobile terminals 10′ may be embodied as or otherwise include an apparatus 30 as generically represented by the block diagram of FIG. 3. In this regard, the apparatus may be configured to provide for communications with the AP 12 or another terminal(s) via communications system (e.g., a Wi-Fi system, a WLAN system). While the apparatus may be employed, for example, by a mobile terminal, it should be noted that the components, devices or elements described below may not be mandatory and thus some may be omitted in certain embodiments. Additionally, some embodiments may include further or different components, devices or elements beyond those shown and described herein. As shown in FIG. 3, the apparatus 30 may include or otherwise be in communication with a processing system including, for example, processing circuitry 32 that is configurable to perform actions in accordance with example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 32 may include a processor 34 and memory 36 that may be in communication with or otherwise control a device interface 38 and, in some cases, a user interface 44. As such, the processing circuitry may be embodied as a circuit chip (e.g., an integrated circuit chip) configured (e.g., with hardware, software or a combination of hardware and software) to perform operations described herein. However, in some embodiments taken in the context of the mobile terminal, the processing circuitry may be embodied as a portion of a User Equipment (UE) or other mobile terminal. In an alternative example embodiment, the processing circuitry 32 may be embodied in a modem (e.g., cellular modem 40 and/or non-cellular modem 42).

The optional user interface 44 may be in communication with the processing circuitry 32 to receive an indication of a user input at the user interface and/or to provide an audible, visual, mechanical or other output to the user. As such, the user interface in the context of a mobile terminal may include, for example, a keyboard, a mouse, a joystick, a display, a touch screen, a microphone, a speaker, and/or other input/output mechanisms.

The device interface 38 may include one or more interface mechanisms for enabling communication with other devices and/or networks. In some cases, the device interface may be any means such as a device or circuitry embodied in either hardware, or a combination of hardware and software that is configured to receive and/or transmit data from/to a network and/or any other device or module in communication with the processing circuitry 32. In this regard, the device interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In the illustrated embodiment, for example, the device interface includes a cellular modem 40 (e.g., a UMTS modem, a LTE modem, etc.) for supporting communications with the Node B 12 and an optional non-cellular modem 42 (e.g., a Wi-Fi modem, WLAN modem, Bluetooth (BT) modem, etc.) for supporting communications with other terminals (e.g., a Wi-Fi station(s), a WLAN station(s)), etc.).

In an example embodiment, the memory 36 may include one or more non-transitory memory devices such as, for example, volatile and/or non-volatile memory that may be either fixed or removable. The memory may be configured to store information, data, applications, instructions or the like for enabling the apparatus 30 to carry out various functions in accordance with example embodiments of the present invention. For example, the memory could be configured to buffer input data for processing by the processor 34. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 34 may be embodied in a number of different ways. For example, the processor may be embodied as various processing means such as one or more of a microprocessor or other processing element, a coprocessor, a controller or various other computing or processing devices including integrated circuits such as, for example, an ASIC, an FPGA or the like. In an example embodiment, the processor may be configured to execute instructions stored in the memory 36 or otherwise accessible to the processor. As such, whether configured by hardware or by a combination of hardware and software, the processor may represent an entity (e.g., physically embodied in circuitry—in the form of processing circuitry 32) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein. In one example embodiment, the apparatus 30 may operate in a relay mode as an intermediate node (e.g., mobile terminal 10′) that is configured to receive data from and transmit data to other communication devices (e.g., other apparatuses 30 (e.g., mobile terminals 10), AP 12, neighbor AP 16). In another example embodiment, the apparatus 30 may operate as a station (e.g., mobile terminal 10 (e.g., a Wi-Fi station, a WLAN station)) that is configured to transmit data to and receive data from another apparatus 30 (e.g., mobile terminal 10′) operating in a relay mode and may also be configured to communicate directly with an AP (e.g., AP 12, neighbor AP 16).

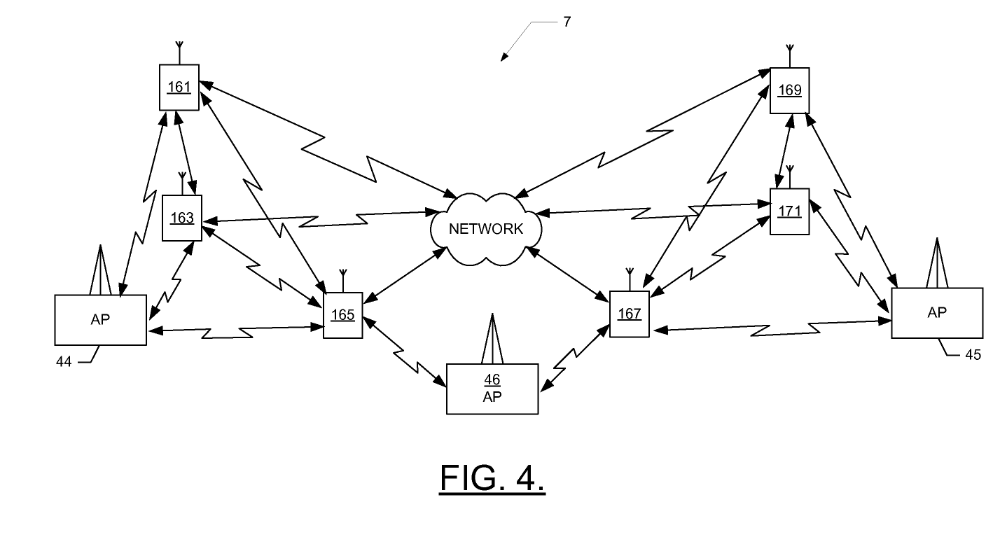

Referring now to FIG. 4, a system is provided according to an example embodiment. The system 7 may include AP 44, (e.g., AP 12), AP 45 (neighbor AP 16), intermediate nodes 165, 167 (also referred to herein as relays 165, 167) (e.g., mobile terminals 10′) and STAs 161, 163, 169 and 171 (e.g., mobile terminal 10). Although FIG. 4 illustrates that the system 7 includes two APs 44, 45, two intermediate nodes 165, 167 and four STAs 161, 163, 169 and 171, the system 7 may include any number of APs 44, 45, intermediate nodes 165, 167 and STAs 161, 163, 169 and 171 without departing from the spirit and scope of the invention.

The relay 165 may facilitate communications between the AP 44 and STAs 161 and 163. The relay 167 may facilitate communications between the AP 45 and STAs 169 and 171. The STAs (e.g., STAs 161, 163, 169 and 171) may communicate with corresponding relays (e.g., relays 165, 167) in an instance in which the STAs operate in a relay mode. When a STA(s) (e.g., STA 161, STA 163, STA 169, STA 171) is not operating in the relay mode, the STA(s) (e.g., STA 161, STA 163, STA 169, STA 171) may communicate directly with an AP(s) (e.g., AP 44, AP 45). For example, in an instance in which the STAs 161, 163 are within a proximity of the AP 44, the AP 44 may communicate directly with the STAs 161, 163. Similarly, in an instance in which the STAs 169, 171 are within a proximity of the AP 45, the AP 45 may communicate directly with the STAs 169, 171. In some example embodiments, a STA(s) may enter the relay mode to communicate with a relay to conserve power since the STA(s) may consume more power when communicating directly with an AP (e.g., the distance to the AP may be further away than the distance to the relay). In other example embodiments, a STA(s) may enter the relay mode for any suitable reason(s). In some example, embodiments, the STAs 161, 163, 169, 171 may communicate directly with each other. In addition, the APs 44, 45 may communicate directly with each other.

In one embodiment a mode of operation is chosen, for example by an AP (e.g., AP 44, AP 45), the mode of operation being a normal DCF operation versus an operation with a delayed ACK (also referred to herein as a delayed ACK mode of operation). In the normal DCF operation, each recipient (e.g., an intermediate node (e.g., a relay) and a destination node (e.g., an AP)) of a packet or multiple packets may send an ACK (e.g., when a single packet is received) or block ACK (e.g., when multiple packets are received) notifying the sender of the successful reception. Additionally, in the normal DCF operation, a sender (e.g., a STA (e.g., STA sending data to a relay) or a relay (e.g., a relay sending data to an AP)) of traffic may delete the traffic data (e.g., a packet(s)) from a buffer as soon as the sender receives an ACK or block ACK from a recipient (e.g., a relay (e.g., acknowledging data received from a STA) or an AP (e.g., acknowledging data received from a relay)) of the traffic data. On the other hand, in the instance of a delayed ACK, a sender (e.g., a STA, a relay) may store the traffic (e.g., one or more packets) received during a time interval of an aggregation period until a final destination node (e.g., an AP) acknowledges reception of the traffic. In an example embodiment, an AP may indicate the mode of operation to communicate devices so that the communication devices are informed of the mode of operation (e.g., a normal DCF operation, a delayed ACK operation) being utilized. As such, an AP (e.g., AP 44, AP 45) may indicate the mode of operation with a single bit or with an Information Element (e.g., 1 octet). For instance, an AP may designate a single bit such as, for example, 0 to denote a Delayed-ACK operation and may utilize a single bit such as, for example, 1 to denote a normal DCF operation.

In another example embodiment, an AP (e.g., AP 44, AP 45) may indicate the mode of operation in an information element and may also include additional information in the information element. In this regard, the information element may indicate a normal DCF operation or a delayed ACK operation. The information element may also indicate a default aggregation period and may indicate one or more predetermined threshold values, as described more fully below. The aggregation period may include two time periods/intervals. In this regard, the aggregation period may include two stages. The first stage may be associated with a first time period/interval for one or more STAs (e.g., STAs 169, 171) to communicate with a relay (e.g., relay 167). As such, the first time period may be a time period in which a relay may receive and aggregate data sent from one or more STAs. The second stage may be associated with a second time period/interval for communications from a relay (e.g., relay 167) to an access point (e.g., AP 45).

In one example embodiment, the indications of the mode of operation, the aggregation period and the thresholds in the information element may be sent in a Request to Send/Clear to Send (RTS/CTS) message(s), which may implement virtual carrier sensing in carrier sense multiple access with collision avoidance (CSMA/CA). For instance, a node desiring to send data may initiate the process by sending a Request to Send (RTS) frame and the destination node may reply with a Clear To Send (CTS) frame. Other nodes receiving the RTS and/or CTS frames may refrain from sending data for a given time before trying to obtain access to the channel. The amount of time to refrain from sending data may be indicated in one or more octets of the RTS and/or the CTS frames. In this example embodiment, the indications denoting the mode of operation (e.g. normal DCF operation, delayed ACK operation), the aggregation period and one or more predetermined threshold values may be included in octets of the RTS/CTS frames.

In another example embodiment, the indications of the mode of operation, the aggregation period and the predetermined threshold values in the information element may be sent in a Quality of service (QoS) Control field or any other field of a Media Access Control (MAC) header (e.g., reserved bits of the MAC header) or a variable length payload.

By indicating the mode of operation, an AP may help communication devices (e.g., a relay(s), a STA(s), an AP(s)) to decide whether they need to acknowledge received traffic and/or store the traffic until they receive an ACK indicating that the traffic was successfully received.

In one example embodiment, the aggregation period and one or more threshold values may be designated and stored in a memory (e.g., memory 36) of communication devices (e.g., a relay(s), a STA(s), an AP). As such, in an instance in which a single bit is used to denote the mode of operation and in which a communication device(s) detects that the bit (e.g., bit “0”) denotes the delayed ACK mode of operation, the communication device(s) may be configured determine to utilize the designated aggregation period and the predetermined threshold values.

In one example embodiment, a recipient device (e.g., relay 167) may delete stored traffic data (e.g., one or more packets) even in an instance in which an ACK under the delayed ACK mode is not received from an AP (e.g., AP 45) in an instance in which the recipient device (e.g., relay 167) receives another set of packets from the same sender device (e.g., STA 169) or the same group of sender devices (e.g., STAs 169, 171).

A sender device or group of sender devices may not be allowed (e.g., prohibited) to send new traffic before the previous traffic is acknowledged which denotes that the recipient device may have lost the ACK or block ACK sent by an AP (e.g., AP 167).

In other words, in this example embodiment the AP (e.g., AP 167) may have sent an acknowledgement to a sender device (e.g., STA 169) or group of sender devices (e.g., STAs 169, 171), indicating that the AP successfully received traffic data initially sent from the sender device (e.g., STA 169) or group of sender devices (e.g., STAs 169, 171). However, the recipient device (e.g., relay 167) may not have received the ACK. As such, the recipient device (e.g., relay 167) may be unaware that the traffic has been successfully delivered to the AP. In this manner, in an instance in which the recipient device (e.g., relay 167) receives a new set of packets from a sender device (e.g., STA 169) or a group of sender devices (e.g., STAs 169, 171) the recipient device (e.g., relay 167) may determine that the previous traffic is successfully delivered and as such the recipient device (e.g., relay 167) may delete the previously stored traffic (e.g., deleted from a buffer in a memory (e.g. memory 36)).

In an instance in which a recipient device (e.g., relay 167) does not receive traffic from a STA(s) (e.g., STA 169) for a given time period (e.g., a predefined time period) even though the recipient device (e.g., relay 167) has received an ACK from a destination node (e.g., AP 167) of the previous set of packets sent over an aggregation period, the recipient device may determine that the STA(s) lost the ACK (or a block ACK) and may resend the ACK (or a block ACK) to the STA(s) (e.g., STA 169).

In other words, even though the AP has acknowledged receipt of the package initially sent by a STA(s) (e.g., STA 169) and forwarded to the AP by the recipient device, the STA(s) (e.g., STA 169) may not have detected the ACK and may not send any additional data to the recipient device (e.g., relay 167) since the ACK was not detected. Since the recipient device (e.g., relay 167) is aware that the ACK was sent by the AP, the recipient device may resend the ACK to the STA(s) to enable the STA(s) (e.g., STA 169) to send additional traffic data.

In one example embodiment, a new block ACK frame format may be defined by a processor (e.g., processor 24) of an AP (e.g., AP 44, AP 45). The block ACK may indicate an aggregation period over which a recipient of the block ACK (e.g., a sender of traffic (e.g., STAs 161, 163, 169, 171)) may transmit data packets. The aggregation period may be single packet transmissions according to DCF channel access from a given STA or a group of STAs corresponding to different access classes. Single packet transmissions according to DCF channel access from a group of STAs corresponding to different access classes. Additionally, the aggregation period may be a single transmission opportunity (TXOP) from a STA or an AP. Alternatively, the aggregation period may be multiple TXOPs (e.g., Enhanced Distributed Channel Access (EDCA) or Hybrid Coordination Function Controlled Channel Access (HCCA)) from different STAs.

In another example embodiment, an aggregation period may be one or more Restricted Access Window (RAW) slots. For instance, an AP may assign or schedule a RAW time slot to one or more STAs and the RAW time slot may be designated as the aggregation period in which the STA(s) transmits data. Alternatively, in another example embodiment, an AP may schedule or assign less than an entire RAW time slot for aggregating data. For instance, the RAW time slot may be divided such that a first time period (e.g., an aggregation time period) of the RAW slot is designated for STA/AP to relay communications (e.g., aggregated data) and a second time period for relay to STA/AP communications.

In one example embodiment, an AP may determine the size/length of the aggregation period from STA specific parameters and the size/length may also depend on: (1) a relay type and capabilities (e.g., capabilities of a relay to buffer frames); (2) the link quality between the relay and an AP (e.g., such that the relay may deliver data to a final destination node at a reasonable time); (3) the traffic quantity and the type of traffic (e.g., voice, video, background, best effort, etc.); (4) STA energy efficiency requirements and type of device (e.g., limited capability sensor device; (5) in a degenerate case, the size of the aggregation period may be the size of a single packet; (6) uplink data indication information may be utilized to determine the size of the aggregation period; or (7) any other suitable parameters.

In one example embodiment, a processor of an AP may designate/define aggregation periods that may be different for different STAs but which are unique for a group of STAs. The block ACK frame under the normal DCF operation may be sent unconditionally to acknowledge a set of packets sent by a sender or group of senders. In other words, a block ACK is sent by a recipient device (e.g., a relay) according to the normal DCF operation in response successfully receiving data (e.g., a set of data packets) from a sender device(s) (e.g., a STA(s)).

Additionally, a new block ACK under the delayed ACK mode may be sent by a relay in an instance in which the amount of traffic satisfies certain traffic conditions and in which the new block ACK indicates a new aggregated period. The conditions include that the traffic received by the relay satisfies the following: (1) the amount of traffic is less than a predetermined threshold, for example, the relay has received too little traffic (e.g., less than the predetermined threshold) from a sender device (e.g., a STA(s) or an AP); and (2) the relay may aggregate more packets before delivery to a destination node (e.g., an AP or a STA(s)).

In this regard, a processor (e.g., processor 34) of a relay (e.g., relay 167) may increase the aggregation period in an instance in which an amount of the received traffic is (1) less than the first predetermined threshold and (2) the relay has received too little traffic (e.g., less than first predetermined threshold) from a sender device (e.g., a STA(s) or an AP).

On the other hand, a processor (e.g., processor 34) of a relay (e.g., relay 167) may decrease the aggregation period in an instance in which an amount of the received traffic is (1) larger than a second predetermined threshold (e.g., 90%) and (2) the relay has aggregated too much traffic (e.g., more than the second predetermined threshold) from a sender device (e.g., a STA(s) or an AP). In this regard, the relay may decrease the aggregation period to slow down the sender device(s) from sending data to avoid causing a buffer of the relay to overflow.

In another example embodiment, the processor (e.g., processor 34) of a relay (e.g., relay 167) may decrease the aggregation period in response to determining that a ratio of incoming to outgoing traffic exceeds a third predetermined threshold. In this regard, the processor of the relay may determine that the link of relay to destination node (e.g., an AP or STA(s)) is too slow as compared to the link from the source(s)/sender device(s) to the relay.

In another example embodiment, the processor (e.g., processor 34) of a relay (e.g., relay 167) may increase the aggregation period in response to determining that a ratio of incoming to outgoing traffic is less than a fourth predetermined threshold. In this regard, the processor of the relay may determine that the link of relay to destination node (e.g., an AP or a STA(s)) is too fast as compared to the link from the source(s)/sender device(s) to the relay. As such, the relay may need to aggregate more traffic data.

In one example embodiment, the updated aggregation period may be a new aggregation period value in the block ACK. For instance, a new value (e.g., a value indicating 20 ms, etc.) may be included in a field of an ACK having an aggregation period. In another example embodiment, the updated aggregation period may include the old aggregation period along with an offset in which the period may be increased or decreased in the block ACK. For purposes of illustration and not of limitation, the block ACK may indicate twenty milliseconds for the old aggregation period and an offset of ten milliseconds along with an indication that the aggregation period should be increased. As such, a relay may determine that the updated aggregation period is thirty milliseconds (e.g., old aggregation period plus the offset (e.g., 20 ms+10 ms=30 ms)). On the other hand, in another example for purposes of illustration and not of limitation, the block ACK may indicate twenty milliseconds for the old aggregation period and an offset of ten milliseconds along with an indication that the aggregation period should be decreased. In this regard, the relay may determine that the updated aggregation period is ten milliseconds (e.g., old aggregation period minus the offset (e.g., 20 ms−10 ms=10 ms)).

In another example embodiment, the old aggregation period may not necessarily be included in the new block ACK since the sender devices previously using the old aggregation period may know the time period associated with the old aggregation period. In this alternative example embodiment, a processor of a relay may include the offset and indication to increase or decrease in the block ACK and the sender device(s) may determine the new aggregation value by using the old aggregation value and the offset information.

A purpose of the block ACK may be to achieve MAC level flow control. In this regard, higher layer flow control mechanisms may be combined. The block ACK may be sent to a STA or to a group of STAs (e.g., uncasted or broadcasted). The recipient address of the block ACK may be a regular MAC address or a group address.

In an alternative example embodiment, the processor of a relay may include the elements of a new block ACK in a completely new frame format. In this regard, it may not be necessary to modify a block ACK to include an updated aggregation period. Instead, a new frame may be defined indicating a change in an aggregation period.

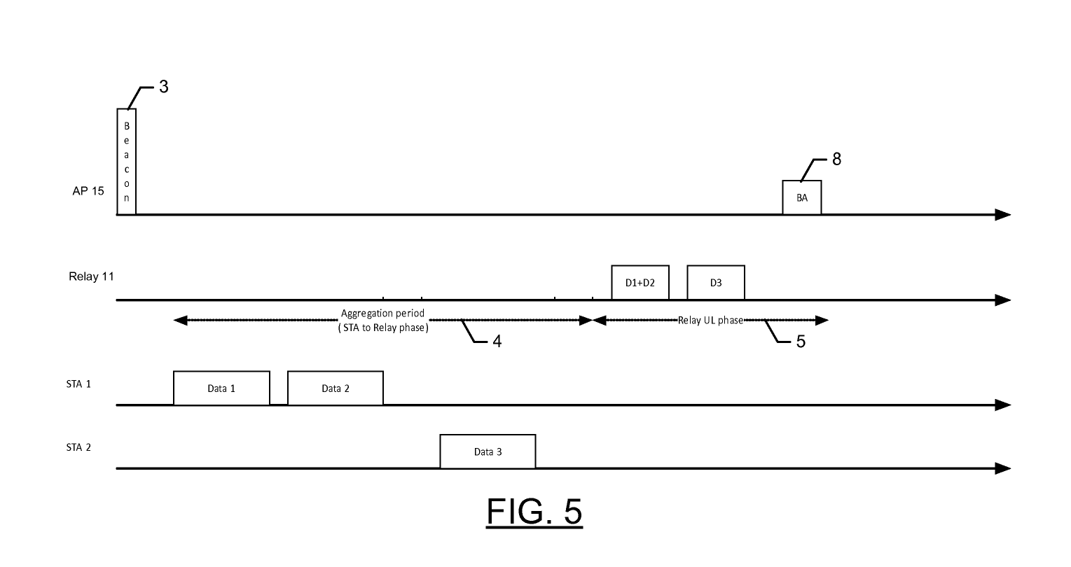

Referring now to FIG. 5, a diagram illustrating information exchange between communication devices is provided according to an example embodiment. In particular, FIG. 5 illustrates an exemplary non-limiting embodiment of information exchange between STAs and a relay 11 and an AP 15. The AP 15 (e.g., AP 44) may indicate in the beacon 3 that STA 1 (e.g., STA 161) and STA 2 (e.g., STA 163) may access a channel (e.g., by setting traffic indication map (TIM) bits) for communication. The beacon 3 may also specify a delayed ACK mode of operation and may indicate an aggregation period. The beacon may be transmitted by the AP (e.g., by using broadcast or multicast transmission) and may be detected by STAs 1 and 2 and the relay (e.g., relay 165).

In the example embodiment of FIG. 5, STA 1 may transmit two data packets (e.g., data 1 and data 2) to the relay (e.g., relay 165) during the duration of the aggregation period 4 and STA 2 may transmit a data packet (e.g., data 3) to the relay 11 (e.g., relay 165) in the duration of the aggregation period 4.

During the relay uplink (UL) phase 5, the relay may aggregate the data packets (e.g., data 1, data 2, data 3) and send the aggregated data packets (e.g., data 1, data 2, data 3) to the AP 15 (e.g., AP 44). Alternatively, during the relay uplink phase 5 the relay 11 may send the data packets separately to the AP 15. In response to receipt of the data packets, the AP 15 may acknowledge the successful receipt of the data packets by sending a block ACK (BA) 8. In an example embodiment, the STA 1 and STA 2 may listen to the transmission(s) (e.g. broadcast, unicast or multicast transmission(s)) of the AP and may detect the block ACK 8 indicating delivery acknowledgement of their respective data packets. In an alternative example embodiment, in an instance in which STA 1 and STA 2 may be unable to hear (e.g., STAs 1 and 2 may be too far away from the AP) the transmission(s) (e.g. broadcast, unicast or multicast transmission(s)) of the AP, the relay may detect the block ACK and may send the block ACK to STA 1 and STA 2 indicating delivery acknowledgement of their respective data packets.

In the reverse link operation (e.g., from AP to STA(s) via a relay) the relay UL phase becomes a relay downlink (DL) phase and is before the aggregation period. The reverse link operation may be indicated in a beacon, for example, by setting the TIM bitmap. The full TIM bitmap contains as many elements as the number of association identifiers (AIDs) of the associated STAs in the network. If the TIM bit corresponding to a STA is set to one then the AP has downlink traffic for this STA. If the TIM bit corresponding to a STA is set to zero then the AP does not have buffered traffic for the STA.

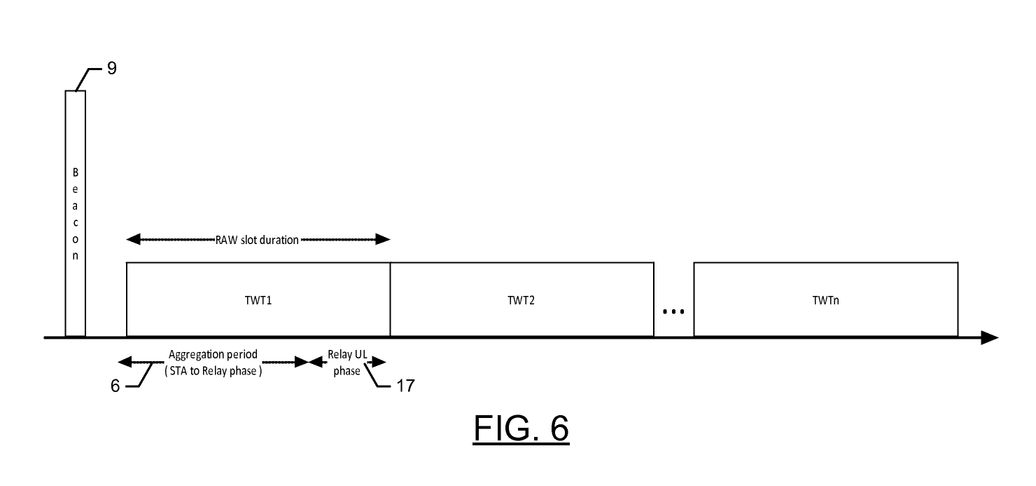

Referring now to FIG. 6, a diagram illustrating RAW time slots for communications is provided according to an example embodiment. In the example embodiment of FIG. 6, an AP may transmit a signal (e.g., a beacon) (e.g., in broadcast or multicast manner) to one or more STAs and a relay(s). The beacon may include data indicating a delayed ACK mode of operation and may indicate an aggregation period.

The AP (e.g., AP 44) may also designate or assign RAW time slots for usage by one or more STAs and a relay(s). For instance, each RAW slot may be assigned to a respective STA. In this regard, for example, RAW time slot Target Wake Up Time (TWT) 1 (also referred to herein as TWT1) may be assigned to a STA (e.g., STA 163), RAW time slot TWT2 may be assigned to another STA (e.g., STA 161) so on and so forth until TWTn is assigned to a STA n. The assigned RAW time slots may be transmitted by the AP to respective STAs (e.g., STA 161, STA 163) and a relay(s) (e.g., relay 165). In one example embodiment, a RAW time slot (e.g., TWT1) may be divided between an aggregation phase and a relay uplink phase. As such, the aggregation phase 6 may be a first time period (also referred to herein as STA to relay phase) of the RAW time slot (e.g., TWT1) designated for STA to relay communications and the relay uplink phase 17 may be a second time period (also referred to herein as relay UL phase) of the RAW time slot designated for communications between the relay (e.g., relay 165) and the AP (e.g., AP 44). Alternatively, in another example embodiment a RAW time slot may similarly be divided for the downlink transmission from an AP to a relay and from the relay to a STA or group of STAs.

In this example, one or more items of data (e.g., two data packets) may be received by the relay during the aggregation phase (e.g., the first time period) of the RAW time slot (e.g., TWT1). The relay may aggregate the items of data and send the items of data to the AP during the relay to uplink phase (e.g., a second time period) of the RAW time slot (e.g., TWT1). During the relay uplink phase, the AP may also broadcast/transmit a block ACK indicating successful receipt of the items of data (e.g., two data packets). In an instance in which the STA may hear (e.g., STA is within a proximity of the AP) communications from the AP, the STA may detect the block ACK indicating successful receipt of the items of data. In an instance in which the STA may be unable to hear/detect the broadcast/transmission of the block ACK from the AP, the relay may detect the block ACK and may send it to the STA indicating successful receipt of the items of data by the AP.

In another alternative example embodiment, an entire RAW slot (e.g., TWT2) may be assigned by an AP (e.g., AP 44) as an aggregation period for communications between a STA(s) (e.g., STA 163) and a relay (e.g., relay 165). In this regard, the AP may assign another RAW time slot (e.g., TWTn) for a relay uplink phase designated for communications between the relay and the AP. In yet another alternative example embodiment, in the reverse link operation (e.g., from AP to STA via a relay), a downlink (DL) phase may be followed by a de-aggregation period.

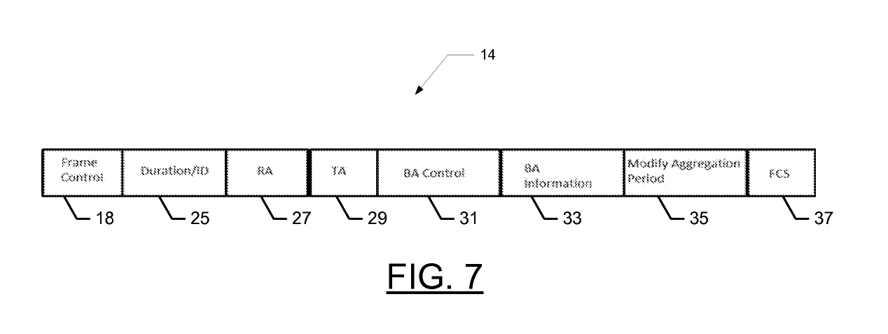

Referring now to FIG. 7, a diagram of a block ACK indicating an aggregation period is provided according to an example embodiment. The block ACK 14 may include a frame control field 18 and a duration/ID field 25, which may include an estimate of the amount of time that is required by a relay to deliver items of data (e.g., traffic, packets) to an AP. The receiver address (RA) field 27 may include data indicating a STA or group of STAs that requested a block ACK. The transmitter address (TA) field 29 may include data indicating a relay sending the block ACK. For instance, the TA field may include data indicating a relay sending the block ACK, received from an AP, to one or more STAs. The block ACK (BA) control field 31 may include BA control signal information. The BA information field 33 may include data indicating a block ACK bitmap. The block ACK 14 may also include a Frame Check Sequence (FCS) field 37. The FCS includes a cyclic redundancy check (CRC) for error detection.

The modify aggregation period 35 may include data indicating an updated or modified aggregation period. In an example embodiment, a relay may modify the aggregation period of a block ACK. Options for modifying the aggregation period are described below

With respect to the first option, the modification (e.g., increase/decrease) of the aggregation period (e.g., an aggregation period initially assigned by an AP) may be provided either with a bit (for example, to indicate the truncation/increase) and/or a field indicating the change in the aggregation period. In one example embodiment, a relay may utilize a single bit together with a change value to indicate a modified aggregation period. This information may be utilized by a relay as follows: (a) (1, duration) in an instance in which the previous value was 1, the aggregation period stays the same; (b) (0, duration) given that the previous value was 1, the aggregation period decreases by duration; (c) (1, duration) given that the previous value was 0, the aggregation period increases by duration; (d) (0, duration) given that the previous value was 0, the aggregation period stays the same. In one example embodiment, the previous aggregation period may, but need not, also be included in the modify aggregation period field.

Regarding a second option, a relay may update data of the modify aggregation period field by indicating a value (e.g., 100 ms, 50 ms, etc.) of the new aggregation period chosen.

The new block ACK 9 frame may be indicated, for example by a relay, in the type/subtype fields by using the reserved values. For instance, all the values of type B3B2=11 and subtype B7 B6 B5 B4=0000-1111 are reserved as well as the values of type B3 B2=01 and subtype B7 B6 B5 B4=0000-0110. It can further indicate in the type/subtype whether block ACK is used for the Delayed-ACK mode (Mode A). The type/subtype fields are part of the Frame control field (e.g., frame control field 18) of a MAC frame. Two bits are reserved for the type and four bits for the subtype. These bits may indicate the type of frame, for example, if it is a management, control, data, or reserved frame.

As described above, some example embodiments may utilize two modes operation. In one mode of operation a delayed ACK operation is provided. In this regard, one or more STAs (e.g., STA 169, STA 171) and/or an AP (e.g., AP 45) may transmit data to a relay (e.g., relay 167).

Depending on the outcome of the reception of the relay of the packets received by a STA(s) or an AP during an aggregation period, a relay (e.g., relay 167) may perform the following. In an instance in which all the packets are successfully received, a relay may not send an acknowledgement before final delivery to the AP (e.g., in the uplink)/STA (e.g., in the downlink). In an instance in which the number of packets that are successfully received by the relay satisfies the conditions triggering a block ACK, the relay (e.g., relay 167) may perform the following. During a STA-based aggregation period, the relay may send a message to a STA(s) (e.g., STA 171) and/or AP (e.g., AP 45) indicating that the relay needs to increase/decrease the aggregation period. The message may indicate the beginning of a new aggregation period or may indicate to increment or decrement an offset and optionally may indicate the previous aggregation period. Additionally, the message may be a block ACK that along with a new aggregation period further indicates any lost packets to be retransmitted during the aggregation period.

During a group-based aggregation period, a relay (e.g., relay 167) may send a message to the group of STAs (e.g., STA 169, STA 171). In one example embodiment, a message may be sent through a RAW time slot(s) and in each RAW time slot a relay may send to the corresponding STA/AP an indication about a new aggregation period and a block ACK indicating any lost packets.

In an instance in which some of the packets from the one or more STAs (e.g., STA 169, STA 171) or an AP (e.g., AP 45) during the aggregation period fail but the number of successfully received packets exceeds a threshold. The relay may postpone signaling the STAs/AP regarding the outcome of its reception and may attempt to deliver the packets successfully received to the AP and/or to the STAs. The STAs may be informed later either by the relay or by the AP regarding which of the packets sent during the aggregation period are successfully delivered to the AP. In the case of downlink traffic, the AP may be informed later by the relay regarding the outcome of an end-to-end transmission.

In another mode of operation a DCF operation is provided. Depending on the outcome of reception of one or more packets received by one or more STAs and/or an AP during an aggregation period a relay (e.g., relay 165) may perform the following. In an instance in which all the packets are successfully received, the relay may send a block ACK with a bitmap equal to one before final delivery to an AP (e.g., AP 44) and/or to the STAs (e.g., STA 161, STA 163). Additionally, the relay may signal the STAs/AP about increasing or decreasing the aggregation period window, e.g., based on the observed delays, its buffer status, etc.

In an instance in which some packets fail to be received successfully at the relay, during a STA-based aggregation period, the relay may send a message to the STA(s)/AP indicating the identities of the packets that are lost or successfully received.

The message may indicate the beginning of a new aggregation period. A new aggregation period may be needed, for example, in an instance in which the number of packets successfully received is very low (e.g., below a threshold). The message may also indicate whether the aggregation period has to be increased or decreased. The message may be a block ACK.

During a group-based aggregation period, the relay (e.g., relay 165) may send a message to a group of STAs (e.g., STA 161, STA 163) to indicate the identities of the packets that were received successfully or failed. A message may be sent through a RAW time slot and in each RAW time slot a relay may send to the corresponding STA(s) an indication about a new aggregation period.

A new aggregation period may be needed in an instance in which the number of packets successfully received is very low (e.g., below a threshold). In this regard, a block ACK or a normal ACK with the outcome of the packet transmissions may be provided.

Subsequently, a relay(s) (e.g., relay 165) may transmit the packets received during the aggregation period to a AP (e.g., AP 44) or to one or more STAs (e.g., STA 161, STA 163) by using another aggregation period. The transmission from the relay(s) to the AP and/or from the relay(s) to the one or more STAs may be according to Enhanced Distributed Channel Access (EDCA) or according to some scheduled access scheme (e.g., Hybrid Coordination Function (HCF), Point Coordination Function (PCF) or RAW access).

In the DCF mode of operation, a relay (e.g., relay 165) may drop packets that it has received during an aggregation period and which have not been acknowledged after the retransmission limit is reached. In an instance in which the retransmission limit is reached at the transmission from the relay to an AP (e.g., AP 44) or from the relay (e.g., relay 165) to one or more STAs and not all packets have been delivered successfully the relay may, in an instance in which an aggregation period is defined per STA, send a block ACK indicating which messages may be dropped at the STAs/AP and which have not been delivered to the AP/STAs.

A block ACK may include a trigger to reduce/increase the size of the aggregation period. In an instance in which an aggregation period is defined per group of STAs and in an instance in which the uplink from STAs to relay has been sent using RAW access time slot, the relay may send in the downlink a block ACK with information on the successful and failed packets per STA. In an instance in which the transmission between the relay and one or more STAs is based on a RAW access time slot, a block ACK may be sent in each RAW time slot. In an instance in which the transmission is based on EDCA, the block ACK may be broadcasted to the STAs.

The block ACK may include a trigger to reduce or increase the size of the aggregation period. In this regard, a relay may drop the successful packets and keep retransmitting the rest of the packets.

In the delayed ACK mode of operation, a relay may not send anything to one or more STAs in some instances. For instance, absence of an ACK may indicate implicitly to the STAs that their data is not delivered to the AP yet. STAs may not send more data to a relay before they receive an ACK that their data was delivered. A relay(s) (e.g., relay 165) and STAs (e.g., STA 161, STA 163) may buffer the transmitted packets until an AP (e.g., AP 44) signals successful reception or not of the transmitted packets. The outcome of the reception by the AP may be signaled in several ways. For instance, the AP indicates successful reception to the relays and the relays can signal the STAs. The AP indicates successful reception to a relay and the relay may signal the STAs.

Both these transmissions may be through a RAW access time slot or EDCA/PCF/HCF. This two hop acknowledgement may be necessary in an instance in which an AP (e.g., AP 44) may be unable to reach a STA(s) (e.g., STA 161) directly. The AP may signal itself, a relay(s) and one or more STAs. This may be possible when the AP may reach the STAs (and thus also a relay). An AP may assign a relay(s) and one or more STAs a common slot in the RAW access time slot where the AP transmits successful reception or not of the packets. A block ACK may be used for that indication acknowledging the successfully transmitted packets and indicating the lost ones. This may be a feasible option when the AP (e.g., AP 44) may reach one or more STAs (e.g., STA 161, STA 163) (and therefore also a relay(s) (e.g., relay 165)).

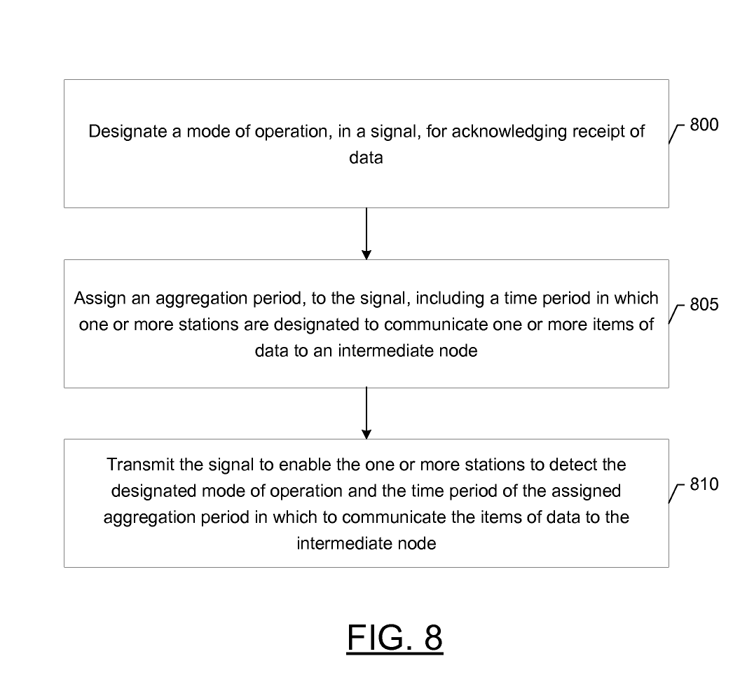

Referring now to FIG. 8, a flowchart is provided of an example method for designating an acknowledgement of data. At operation 800, an apparatus (e.g., AP 12 (e.g., AP 44, AP 45)) may designate a mode of operation (e.g., a delayed ACK mode of operation or a DCF mode of operation), in a signal (e.g., a beacon), for acknowledging receipt of data. At operation 805, an apparatus (e.g., AP 44) may assign an aggregation period to the signal. The aggregation period may include a time period in which one or more stations (e.g., STA 161, STA 163) are designated to communicate one or more items of data (e.g., data packets) to an intermediate node (e.g., relay 165). At operation 810, an apparatus (e.g., AP 12) may transmit the signal to enable the one or more stations to detect the designated mode of operation and the time period (e.g., a STA to relay phase) of the assigned aggregation period in which to communicate the items of data to the intermediate node.

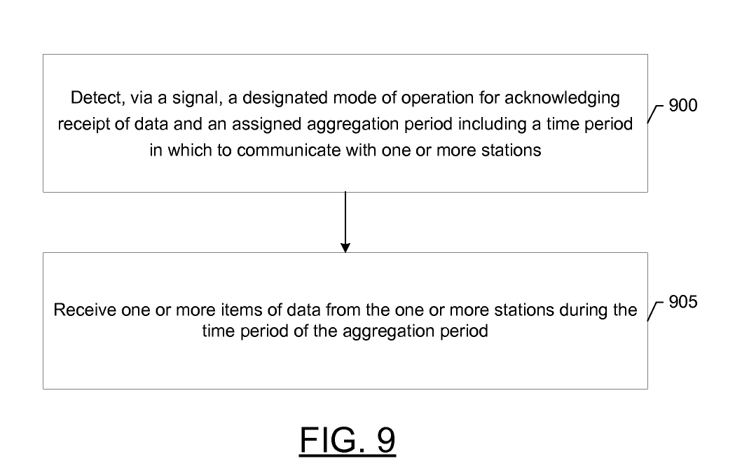

Referring now to FIG. 9, a flowchart is provided of an example method for detecting a designated acknowledgment of data. At operation 900, an apparatus (e.g., relay 165, relay 167 (e.g., mobile terminal 10′)) may detect, via a signal (e.g., a received signal (e.g., a beacon)), a designated mode of operation (e.g., a delayed ACK mode of operation or a DCF mode of operation) for acknowledging receipt of data and an assigned aggregation period including a time period (e.g., a STA to relay phase) in which to communicate with one or more stations (e.g., STA 161, STA 163). At operation 905, an apparatus (e.g., relay 165) may receive one or more items of data (e.g., data packets) from the one or more stations (e.g., STA 161, STA 163) during the time period of the aggregation period.

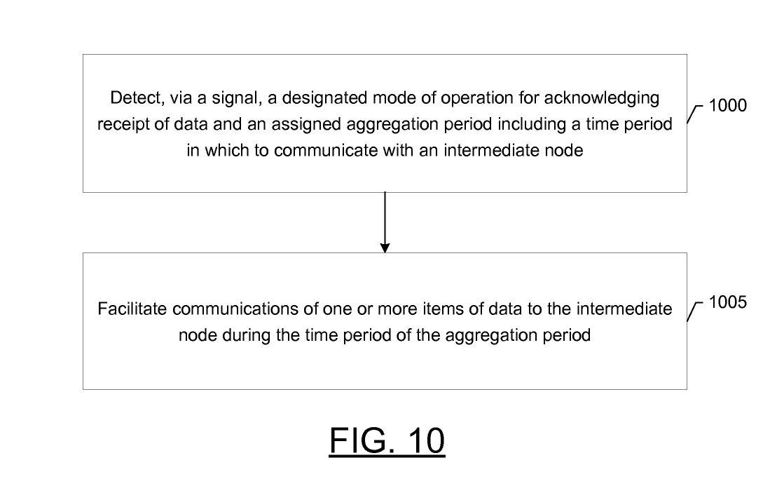

Referring now to FIG. 10, a flowchart is provided of an example method for detecting a designated acknowledgement of data. At operation 1000, an apparatus (e.g., STA 161, STA 163, STA 169, STA 171 (e.g., mobile terminal 10)) may detect, via a signal (e.g., a received signal (e.g., a beacon)), a designated mode of operation (e.g., a delayed ACK mode of operation or a DCF mode of operation) for acknowledging receipt of data and an assigned aggregation period including a time period in which to communicate with an intermediate node (e.g., relay 165, relay 167). At operation 1005, an apparatus (e.g., STA 161) may facilitate communications of one or more items of data (e.g., data packets) to the intermediate node (e.g., relay 165) during the time period (e.g., a STA to relay phase) of the aggregation period.

It should be pointed out that FIGS. 8, 9 and 10 are flowcharts of a system, method and computer program product according to an example embodiment of the invention. It will be understood that each block of the flowcharts, and combinations of blocks in the flowcharts, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory 26, memory 36) and executed by a processor (e.g., processor 24, processor 34). As will be appreciated, any such computer program instructions may be loaded onto a computer or other programmable apparatus (e.g., hardware) to produce a machine, such that the instructions which execute on the computer or other programmable apparatus cause the functions specified in the flowcharts blocks to be implemented. In one embodiment, the computer program instructions are stored in a computer-readable memory that can direct a computer or other programmable apparatus to function in a particular manner, such that the instructions stored in the computer-readable memory produce an article of manufacture including instructions which implement the function(s) specified in the flowcharts blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowcharts blocks.

Accordingly, blocks of the flowcharts support combinations of means for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an example embodiment, an apparatus for performing the methods of FIGS. 8, 9 and 10 above may comprise a processor (e.g., the processor 24, processor 34) configured to perform some or each of the operations (800-810, 900-905, 1000-1005) described above. The processor may, for example, be configured to perform the operations (800-810, 900-905, 1000-1005) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (800-810, 900-905, 1000-1005) may comprise, for example, the processor 24 (e.g., as means for performing any of the operations described above), the processor 34 and/or a device or circuitry for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for designating an acknowledgement of content, the method comprising:
designating a mode of operation, in a signal, for acknowledging receipt of data;
assigning an aggregation period, to the signal, comprising a time period in which one or more stations are designated to communicate one or more items of data to an intermediate node; and
causing transmission of the signal to enable the one or more stations to detect the designated mode of operation and the time period of the assigned aggregation period in which to communicate the items of data to the intermediate node.

2. The method of claim 1, wherein the designated mode of operation comprises a delayed acknowledgement mode of operation in which the intermediate node is not required to acknowledge receipt of the items of data from the one or more stations.

3. The method of claim 2, wherein the delayed acknowledgement mode of operation denotes to the intermediate node to store the items of data received from the one or more stations until an acknowledgement is detected from, a destination node, denoting that the destination node received the items of data.

4. The method of claim 2, wherein the delayed acknowledgement mode of operation denotes to the one or more stations not to communicate additional data to the intermediate node before an acknowledgement is detected.

5. The method of claim 1, wherein assigning the aggregation period further comprises assigning a time interval to receive communications of data from the intermediate node.

6. The method of claim 1, wherein:
the designated mode of operation is indicated in a bit;
a first value of the bit indicates a first acknowledgement mode of operation; and
a second value of the bit indicates a second acknowledgement mode of operation in which the intermediate node is not required to acknowledge receipt of the items of data from the one or more stations.

7. (canceled)

8. The method of claim 1, wherein the designated mode of operation denotes that a destination node acknowledges receipt of the items of data from the intermediate node.

9. The method of claim 5, further comprising:
causing transmission of an acknowledgement during the time interval to enable the one or more stations to detect the acknowledgement indicating that the data was received by a destination node.

10-13. (canceled)

14. An apparatus for designating an acknowledgement of content, the apparatus comprising:
a processing system comprising at least one processor and at least one memory storing computer program code, in which the processing system is arranged to cause the apparatus to at least:
designate a mode of operation, in a signal, for acknowledging receipt of data;
assign an aggregation period, to the signal, comprising a time period in which one or more stations are designated to communicate one or more items of data to an intermediate node; and
cause transmission of the signal to enable the one or more stations to detect the designated mode of operation and the time period of the assigned aggregation period in which to communicate the items of data to the intermediate node.

15. The apparatus of claim 14, wherein the designated mode of operation comprises a delayed acknowledgement mode of operation in which the intermediate node is not required to acknowledge receipt of the items of data from the one or more stations.

16. The apparatus of claim 15, wherein the delayed acknowledgement mode of operation denotes to the intermediate node to store the items of data received from the one or more stations until an acknowledgement is detected from, the apparatus, denoting that the apparatus received the items of data.

17-54. (canceled)

55. A method for detecting a designated acknowledgement of data, the method comprising:
detecting, via a signal, a designated mode of operation for acknowledging receipt of data and an assigned aggregation period comprising a time period in which to communicate with one or more stations; and
receiving one or more items of data from the one or more stations during the time period of the aggregation period.

56. The method of claim 55, further comprising:
determining not to acknowledge receipt of the one or more items of data in response to detecting that the designated mode of operation comprises a delayed acknowledgment mode of operation denoting that an intermediate node is not required to acknowledge receipt of content from the stations.

57. The method of claim 55, further comprising:
detecting that the aggregation period further comprises an assigned time interval to enable transmission of content to a destination node; and
enabling provision of the items of data received from the one or more stations to the destination node during the time interval.

58. The method of claim 55, further comprising:
detecting that a destination node is designated as acknowledging receipt of the items of data in response to determining that the designated mode of operation comprises a delayed acknowledgment mode of operation.

59. The method of claim 55, further comprising:
enabling storage of the items of data until an acknowledgment is received from a destination node in response to detecting that the designated mode of operation comprises a delayed acknowledgment mode of operation denoting to an intermediate node to store content received from the stations until the acknowledgement is received indicating that the destination node received the items of data.

60. (canceled)

61. The method of claim 55, further comprising:
enabling retransmission of an acknowledgement detected from a destination node in response to failing to receive additional data from the one or more stations upon expiration of a predetermined time period, the retransmission enables the one or more stations to detect the acknowledgment to trigger communications of the additional data.

62-66. (canceled)

67. An apparatus for detecting a designated acknowledgement of data, the apparatus comprising:
a processing system comp sing at least one processor and at least one memory storing computer program code, in which the processing system is arranged to cause the apparatus to at least:
detect, via a signal, a designated mode of operation for acknowledging receipt of data and an assigned aggregation period comprising a time period in which to communicate with one or more stations; and
receive one or more items of data from the one or more stations during the time period of the aggregation period.

68. The apparatus of claim 67, wherein the processing system is arranged to cause the apparatus to:
determine not to acknowledge receipt of the one or more items of data in response to detecting that the designated mode of operation comprises a delayed acknowledgment mode of operation denoting that the apparatus is not required to acknowledge receipt of content from the stations.

69. The apparatus of claim 67, wherein the processing system is arranged to cause the apparatus to:
detect that the aggregation period further comprises an assigned time interval to enable transmission of content to a destination node; and
enable provision of the items of data received from the one or more stations to the destination node during the time interval.

70-127. (canceled)
